(19) United States
(12) Patent Application Publication
(10) Pub. No.: US 2010/0279592 A1
(43) Pub. Date: Nov. 4, 2010

(54) Fish Scaling Drill for Scaling Fish

(76) Inventor: Tomas Castaneda, Hialeah, FL (US)

Correspondence Address: RUBEN ALCOBA, ESQ., 3399 NW 72 AVENUE, SUITE211, MIAMI, FL, 33122, US

(21) Appl. No.: 12/433,690

(22) Filed: Apr. 30, 2009

(51) Int. Cl. A22C 25/02

(52) U.S. Cl. 452/101; 452/99

(57) ABSTRACT

The present invention is directed to a fish scaling drill tool for scaling fish. The fish scaling drill tool comprises of a fish scaling drill bit that is used with a drill. The fish scaling drill bit cannot be used with a drill that spins more than five hundred revolutions per minute.

### BACKGROUND

The present invention is related to the field of fish scalers, more specifically a fish scaling drill tool for scaling fish.

The inventor of the present invention was a captain in the merchant marines. During his tenure in the marines, he worked on a fish troller. On the troller he witness old style fish scaling, scaling that is done manually using a simple scaling knife and industrial scaling, heavy duty machines used to scale fish. The time on the troller lead him to develop a scaler that would be used by the masses.

While on the troller, he noticed that the fishermen scaling fish tended to cut their hands repeatedly when scaling fish. The fishermen were professionals, so he correctly assumed that novices would have the same difficulties scaling fish and more so housewives who rarely cooked or cleaned fish. Another reason for developing his idea was to make it more time efficient to scale fish.

For the foregoing reasons, the inventor devised a fish scaling drill tool for scaling fish.

### SUMMARY

The present invention is directed to a fish scaling drill tool for scaling fish. The fish scaling drill tool comprises of a fish scaling drill bit that is used with a drill. The fish scaling drill bit cannot be used with a drill that spins more than five hundred revolutions per minute.

The fish scaling drill bit comprises of a main shaft. The main shaft has two main sections. The first main section is the shank, the shank is inserted within a chuck of a drill. The second main section is the fish scaling section. There might be a third section separating the shank and the fish scaling section, the third section is a buffering section between the shank section and fish scaling section of the fish scaling drill bit.

The fish scaling section comprises of eight rows of ten pyramid shaped protrusion running vertically along the circumference of the shaft of the fish scaling drill bit. The pyramid shaped protrusions form sixty degree angles between each pyramid shaped protrusion. Furthermore, each row's pyramid shaped protrusions are linearly aligned with the protrusions of the other rows so that a sixty degree angle is formed between each adjacent rows' pyramid shaped protrusions.

The fish scaling drill tool is used by first providing the fish scaling drill tool, a user having two hands, and a fish. Then, inserting and securing the bit of the fish scaling drill tool within the chuck of the drill of the fish scaling drill tool, the drill is not to spin more than five hundred revolutions per minute. Next, having the user grasp the fish in one hand. Then, powering the drill of the fish scaling drill tool. And lastly, using the user's other hand to firmly grasp the drill, carefully passing the fish scaling section of the fish scaling drill tool backward and forwards along the body of the fish until the scales have been satisfactorily removed.

An object of the present invention is to provide a fish scaling tool that will prevent a person scaling a fish from cutting his fingers.

Another object of the present invention is to allow a sport fisherman to scale a fish in an efficient manner without having to sully his hands.

Yet, a further object of the present invention is to allow a novice to scale a fish without having to learn to scale a fish using a knife.

### DRAWINGS

These and other features, aspects, and advantages of the present invention will become better understood with regard to the following description, appended claims, and drawings where:

FIG. 1 shows a side view of a fish scaling drill bit;

FIG. 2 shows a top plan view of the fish scaling drill bit, wherein the view runs from the top of the fish scaling section of the fish scaling drill bit towards the shank of the fish scaling drill bit; and

FIG. 3 shows a perspective view of the fish scaling drill bit.

### DESCRIPTION

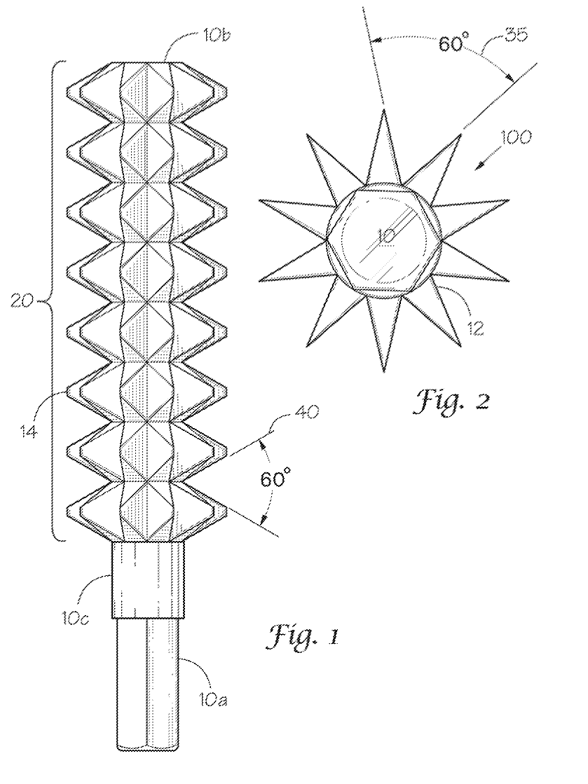

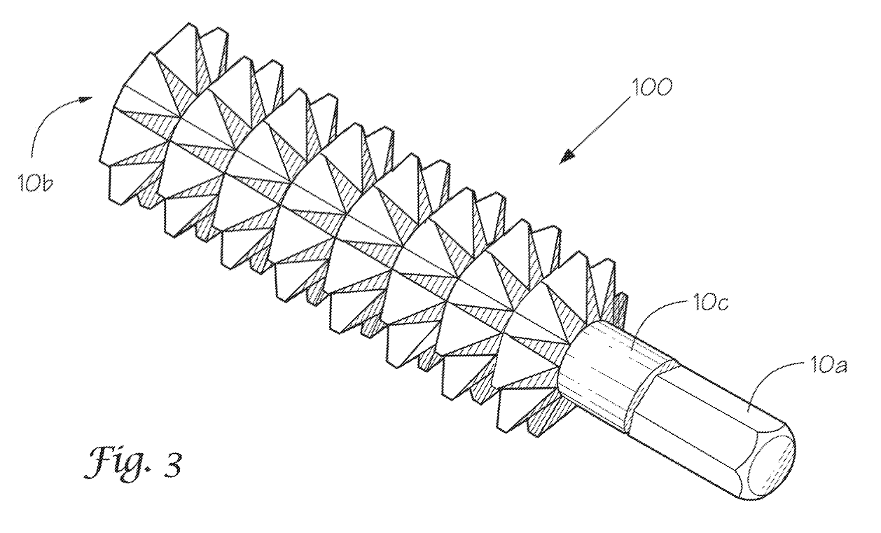

As seen in FIGS. 1-3, a fish scaling drill tool for scaling fish, the tool comprises of a fish scaling drill bit 100 and a drill (not seen in the drawings), the drill has a chuck, and the drill is not to spin more than five hundred revolutions per second, the bit 100 is inserted within the chuck of the drill. The drill is a standard drill and is not shown in the figures.

The fish drill bit 100 comprises of a main shaft 10. The main shaft 10 has two main sections. The first main section is the shank 10a, the shank 10a is inserted within a chuck of a drill. The second main section is the fish scaling section 10b. There might be a third section 10c separating the shank and the fish scaling section, the third section is a buffering section between the shank section 10a and fish scaling section 10b of the fish scaling drill bit.

The fish scaling section 10b of the shaft 10 comprises of eight rows often pyramid shaped protrusions 20 running vertically along the circumference of shaft 10 of the fish scaling drill bit 100. The pyramid shaped protrusions 12 form sixty degree angles 35 between each pyramid shaped protrusion 12. Furthermore, each row's pyramid shaped protrusions 20 are linearly aligned with the protrusions 12 of the other rows so that a sixty degree angle 40 is formed between each adjacent rows' pyramid shaped protrusions 20.

In a preferred embodiment, the top of each protrusion 14 is planar and measures five hundredths of an inch in length and the length of each top 14 runs horizontal to the shaft 10. The diameter of the fish scaling drill bit 100, when measured from the top of one protrusion 14 to the top of a directly opposing protrusion 14, might measure one inch. The fish scaling drill bit 100 might measure approximately four and twenty five hundredths of an inch from the outermost end of the shank 10a to the outermost end of the fish scaling section 10b of the fish scaling drill bit 100.

The fish scaling drill bit 100 is made of materials that are not harmful to humans and that are resistant to wear and tear.

The fish scaling drill tool is used by first providing the fish scaling drill tool, a user having two hands, and a fish. Then, inserting and securing the bit 100 of the fish scaling drill tool within the chuck of the drill of the fish scaling drill tool, the drill is not to spin more than five hundred revolutions per minute. Next, having the user grasp the fish in one hand. Then, powering the drill of the fish scaling drill tool. And lastly, using the user's other hand to firmly grasp the drill, carefully passing the fish scaling section 10b of the fish scaling drill tool backward and forwards along the body of the fish until the scales have been satisfactorily removed.

An advantage of the present invention is that it provides a fish scaling tool that prevents a person scaling a fish from cutting his fingers.

Another advantage of the present invention is that it allows a sport fisherman to scale a fish in an efficient manner without having to sully his hands.

Yet, a further advantage of the present invention is that it allows a novice to scale a fish without having to learn to scale a fish using a knife.

Although the present invention has been described in considerable detail with reference to certain preferred versions thereof, other versions are possible. Therefore the spirit and the scope of the claims should not be limited to the description of the preferred versions contained herein.

1-2. (canceled)

3. A fish scaling drill tool for scaling fish, the tool comprises of a fish scaling drill bit and a drill, the drill has a chuck, and the drill is not to spin more than five hundred revolutions per minute, the fish scaling drill bit comprises of a main shaft, the main shaft has two main sections, the first main section is the shank and the shank is inserted within the chuck of the drill and the second main section is the fish scaling section, the fish scaling section comprises of eight rows of ten pyramid shaped protrusions running vertically along the circumference of the shaft of the fish scaling drill bit and the pyramid shaped protrusions form sixty degree angles between each pyramid shaped protrusion, each protrusion having a top and a bottom and each row's pyramid shaped protrusions are linearly aligned with the protrusions of the other rows so that a sixty degree angle is formed between each adjacent rows' pyramid shaped protrusions.

4. The tool of claim 3, wherein the top of each protrusion is planar and measures five hundredths of an inch in length and the length of each top runs horizontal to the shaft and the diameter of the fish scaling drill bit, when measured from the top of one protrusion to the top of a directly opposing protrusion, measures an inch.

5. The tool of claim 4, wherein the fish scaling drill bit measures approximately four and twenty five hundredths of an inch.

6. A method of using the tool of claim 3, comprising the steps of:
providing the fish scaling drill tool;
providing a user having two hands;
providing a fish;
inserting and securing the bit of the fish scaling drill tool within the chuck of the drill of the fish scaling drill tool;
having the user grasp the fish in one hand;
powering the drill of the fish scaling drill tool; And
lastly, using the user's other hand to firmly grasp the drill and passing the fish scaling section of the fish scaling drill tool backward and forwards along the body of the fish until the scales have been removed.
